(19) United States
(12) Patent Application Publication
(10) Pub. No.: US 2006/0151472 A1
(43) Pub. Date: Jul. 13, 2006

(54) Corrugated electric heating element and related radiant hotplate

(76) Inventors: Angelo Irrera, San Vendemiano (IT); Roberto Sanson, San Vendemiano (IT); Duilio Capraro, Conegliano (IT); Andrea Virzi, Treviso (IT)

Correspondence Address: WENDEROTH, LIND & PONACK, L.L.P., 2033 K STREET N. W., SUITE 800, WASHINGTON, DC, 20006-1021, US

(21) Appl. No.: 10/495,972

(22) PCT Filed: Oct. 15, 2002
(86) PCT No.: PCT/EP02/11495

§ 371 Date: Aug. 22, 2005

(30) Foreign Application Priority Data
Nov. 19, 2001 (IT) PN01U000045

(51) Int. Cl. H05B 3/68

(52) U.S. Cl. 219/461.1; 219/460.1

(57) ABSTRACT

Electric radiant hotplate, suitable also for use in cooking tops, comprising: a base of electrically insulating material, a peripheral crown extending along the outer rim of said base and projecting upwards, at least a strip or resistive material that is inserted in said base dand is formed by a sequence of planar lengths and curved lengths are connected to respective planar appendices that are inserted in the insulating base. In one embodiment, said appendices are connected to the planar lengths by means of respective peduncles applied on to the same side edge of the flat strip of resistive material. In other embodiments, said appendices are either coplanar or not coplanar to said planar lengths, and comprise: a first portion connected to the respective planar length of the strip, at least a second planar portion that is not coplanar with the first portion and is joined to the latter via a rectilinear border, in which said first portions are applied on a same side edge of the flat strip of resistive material.

The present invention relates to an electric heating element of the radiant type, as used in particular, although not solely, in electric cooking tops.

More specifically, the present invention refers to an electric heating element in the shape of an elongated strip of an electrically resistive material, such as metals or special alloys thereof, which is arranged upon or partially inserted in a base of electrically insulating and thermally insulating (refractory) material, and is secured to said base by means of appropriate fastening means.

The present invention also relates to a heating plate, or hotplate, in particular of the type used in household cooking tops provided with an upper smooth glass-ceramic surface, equipped with a radiant heating element according to the present invention.

As far as the prior art is concerned, along with the related drawbacks and peculiar features, this is described in the Italian patent application no. PN2001U000016 filed by this same Applicant, to which reference should therefore be made for reasons of brevity.

The above cited document describes a coiled heating element that is secured in various manners to the related base of insulating material; the technical solution proposed in said patent application has proven particularly advantageous in view of the easiness and inexpensiveness ensured by it in both manufacturing the resistive strip and applying it to the radiant hotplate. However, it also turned up some drawbacks connected with the heat distortion effect that is brought about by the temperature difference that comes to exist between the zones inside or close to the insulating base and the zones outside or far therefrom. Such a problem may even cause the heating element to partially slip out of the recesses in the base in which it is inserted, under easily imaginable negative consequences from both a functional and an aesthetical point of view.

Based on the foregoing considerations, it therefore is a purpose of the present invention to provide a kind of electric heating element of the radiant type, which makes use of a corrugated resistive strip provided with straight attachment pins, and which enables the radiating surface to be maximized while doing away with the above cited heat distortion drawbacks and the mechanical stresses associated therewith.

These aims, along with further features of the present invention, are reached in radiant-type electric heating elements of the kind made and operating in accordance with the characteristics recited in the appended claims.

The present invention can be implemented according to a preferred, however not sole embodiment thereof, which will be described in detail and illustrated below by mere way of non-limiting example with reference to the accompanying drawings, in which:

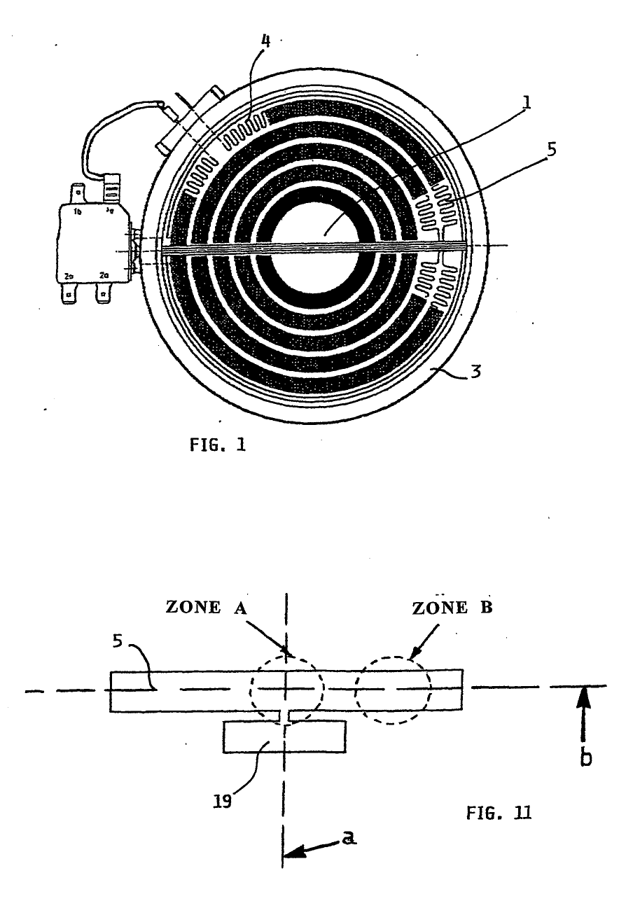

FIG. 1 is a top view of the arrangement of the heating element according to the present invention on a radiant hotplate;

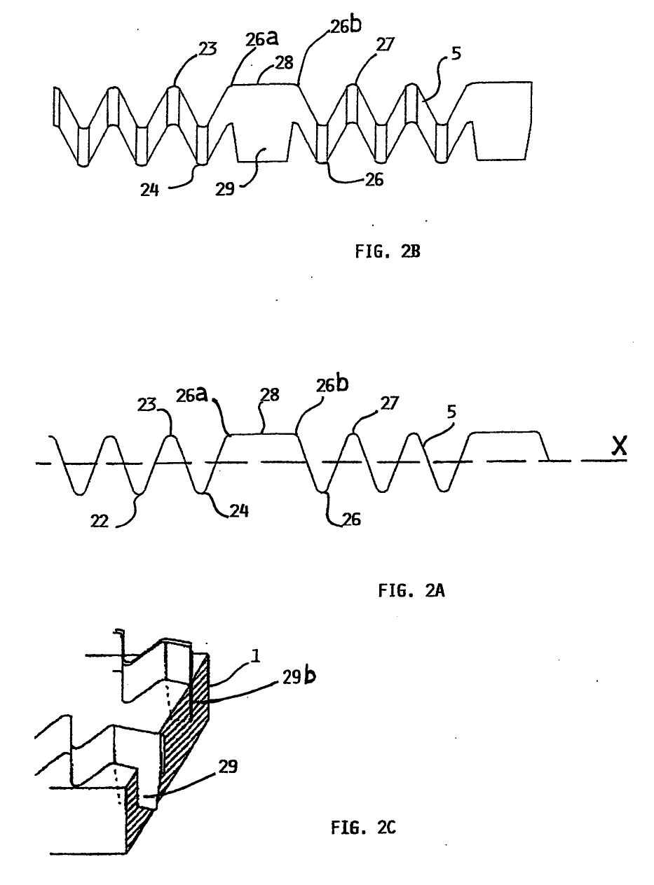

FIGS. 2A, 2B and 2C are views from the top, in a front projection inclined from the top, and in the state in which it is inserted in the insulating base, respectively, of a first embodiment of a heating element according to the present invention;

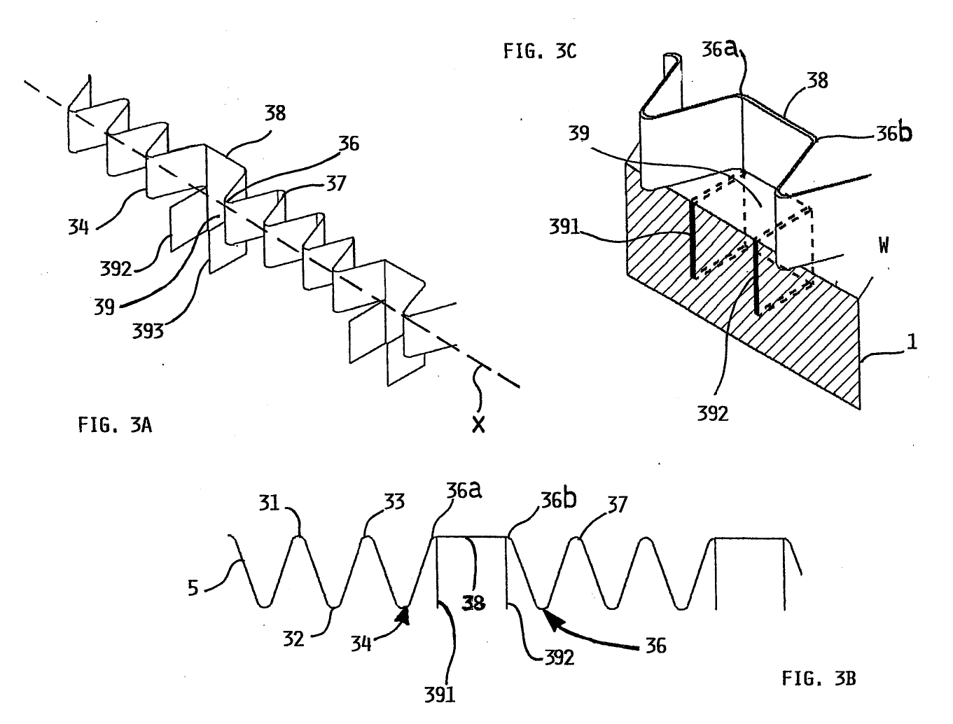

FIGS. 3A, 3B and 3C are top views in axonometric projection, and in the state in which it is inserted in the insulating base, respectively, of a second embodiment of a heating element according to the present invention;

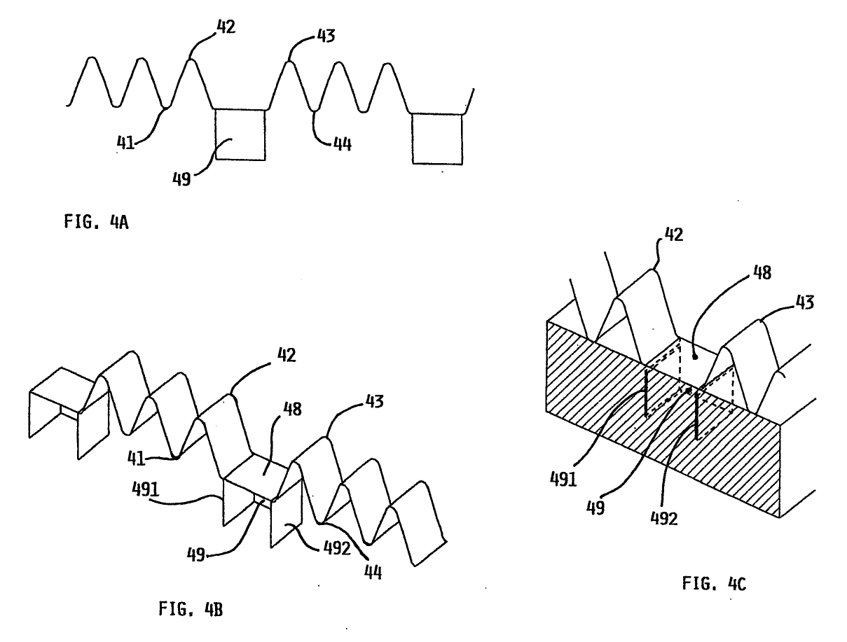

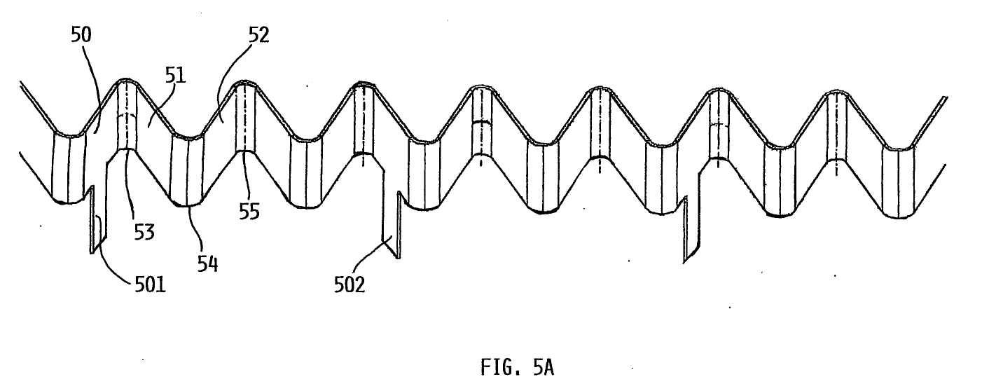

FIGS. 4A, 4B and 4C are side views, in axonometric projection and in the state in which it is inserted in the insulating base, respectively, of a third embodiment of a heating element according to the present invention;

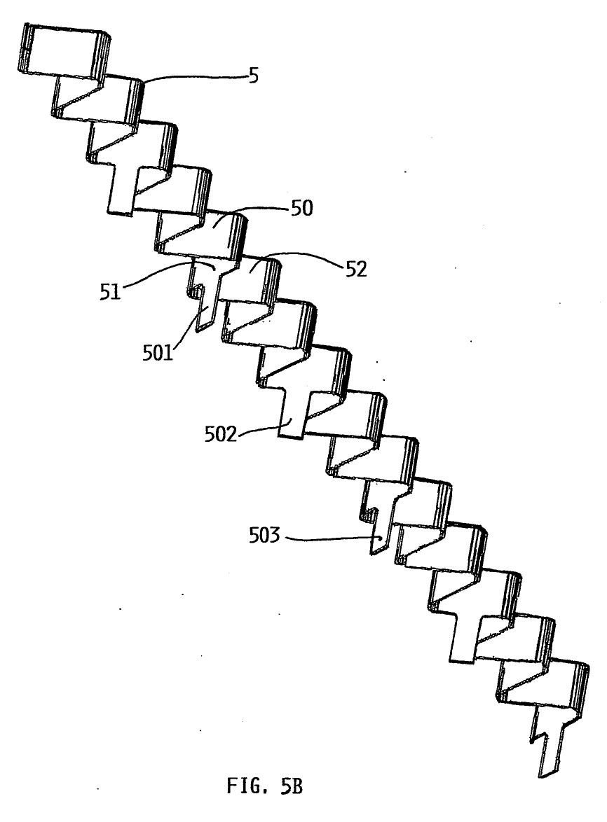

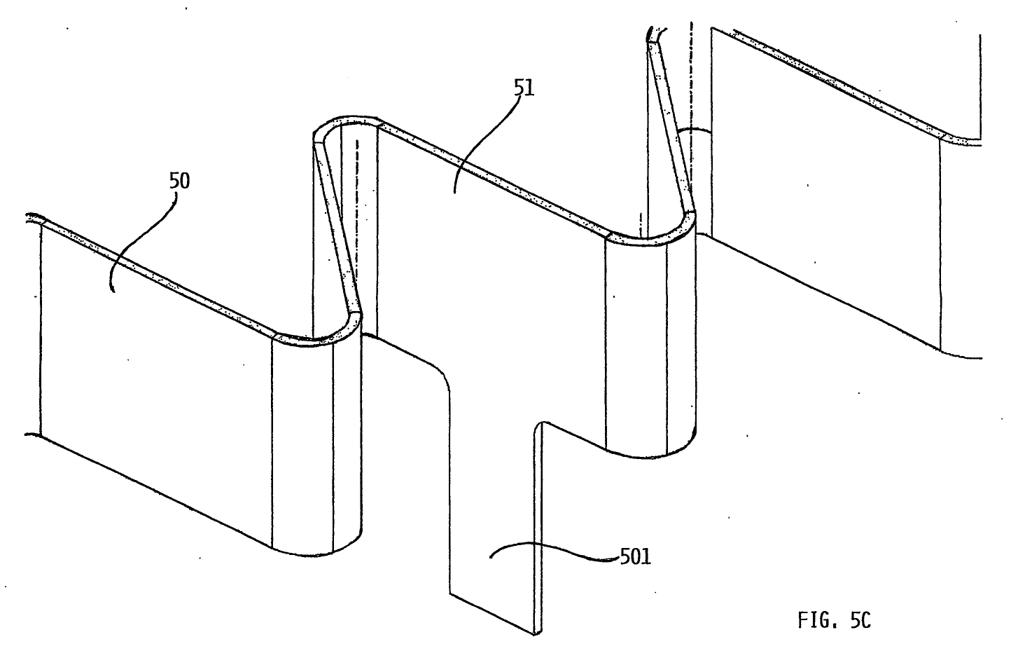

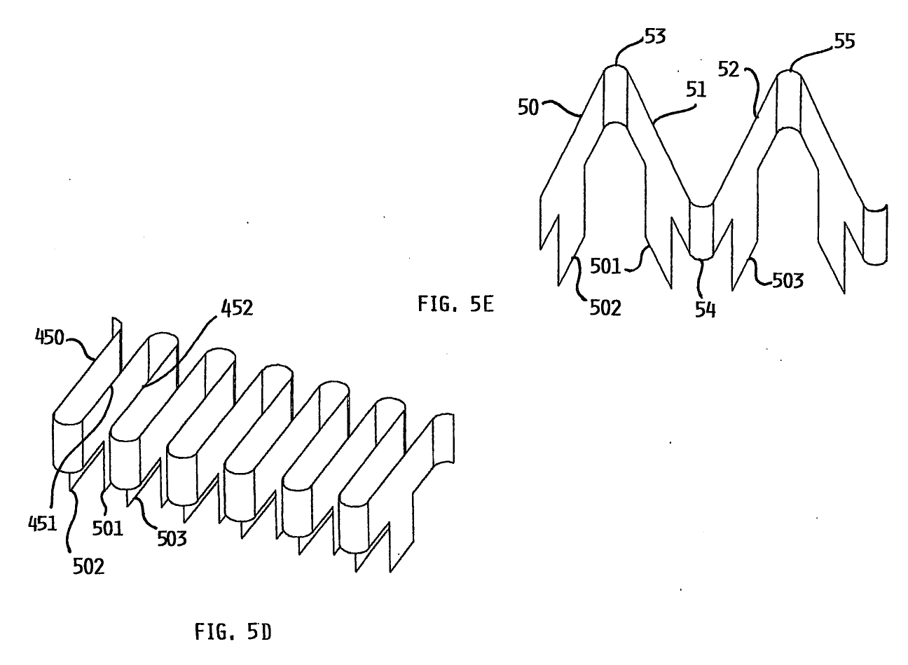

FIGS. 5A, 5B and 5C are respective views of a flat resistive strip, or related enlargement, according to a fourth embodiment of a heating element according to the present invention;

FIGS. 5D and 5E are respective top perspective front and inclined views of a variant of the solutions illustrated in the preceding Figures;

FIG. 6 is a view of a preferred embodiment of a sample piece, or specimen, of resistive strip according to the present invention;

FIG. 7 is a view of the test arrangement used for the specimen of the strip shown in FIG. 6;

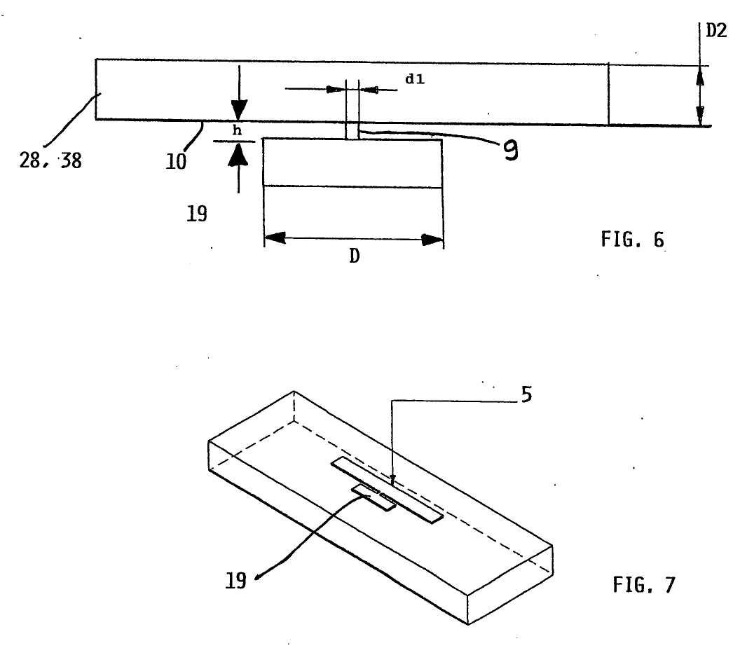

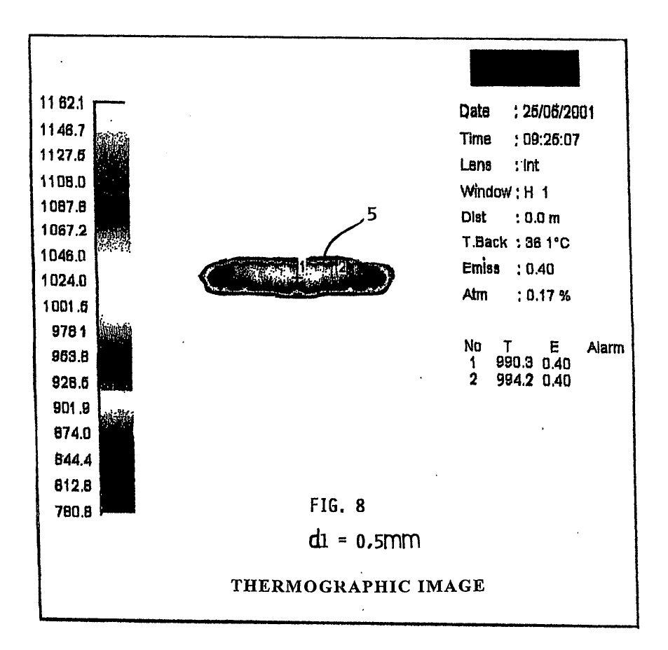

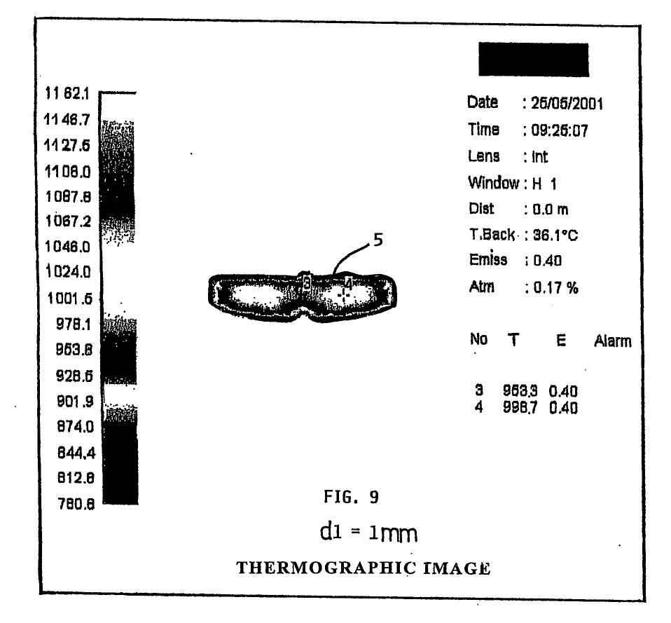

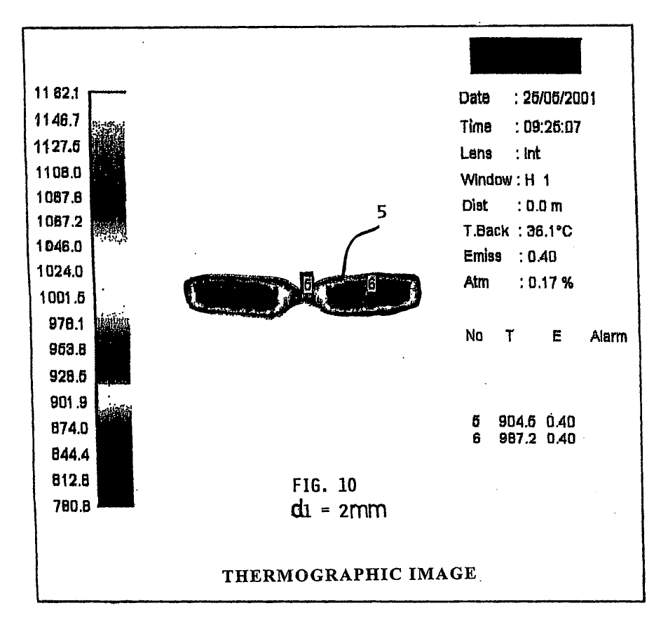

FIGS. 8, 9 and 10 are views of thermographic images of respective specimens of heating element, as generally illustrated in FIG. 6, with different geometrical parameters;

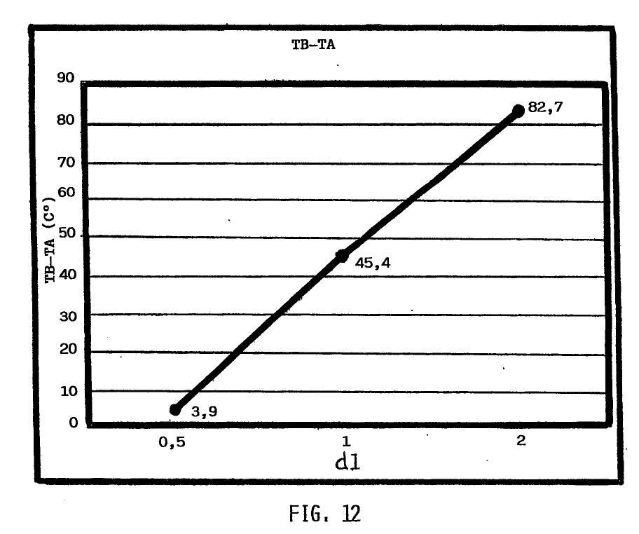

FIGS. 11 and 12 are views of the planar appendix shown in FIG. 6, emphasizing some particular zones of the illustration in FIG. 6, and the related thermal behaviour under regular-operation electric load, respectively;

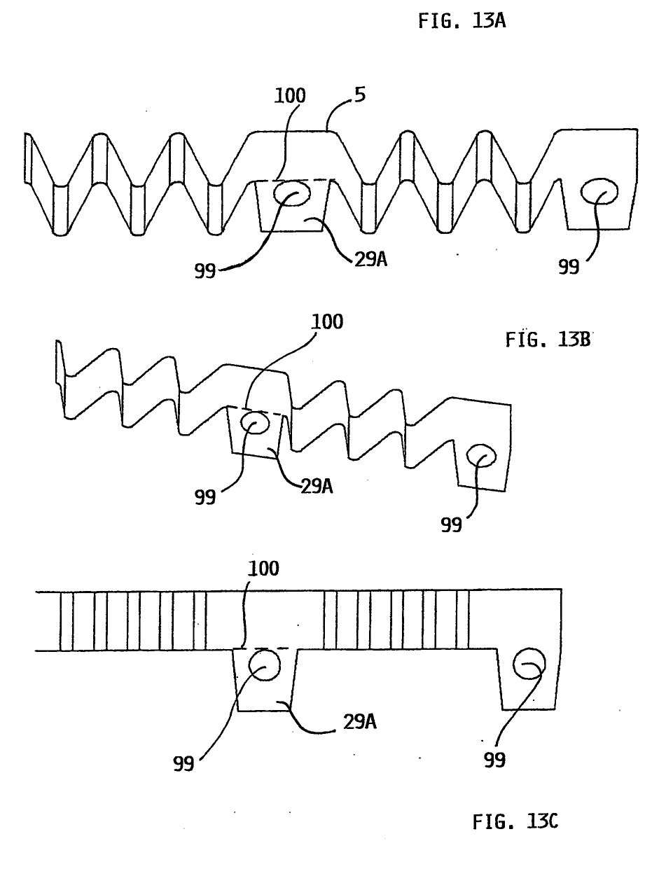

FIGS. 13A, 13B and 13C are a top inclined view, a perspective view and a vertical plane view, respectively, of a particularly advantageous embodiment of a resistive strip according to the present invention.

With reference to the Figures, a radiant-type hotplate according to the present invention substantially comprises:

a base of thermally and electrically insulating material 1,

a circular crown 3 which is provided on the circular rim of said base and projects upwards so as to define an approximately cylindrical space delimited between said base and said circular crown, in which said circular crown is preferably made of the same material used to make said base,

one or more radiant electric heating elements 5 positioned within said approximately cylindrical space.

According to the present invention, said electric heating elements 5 are obtained out of an elongated flat strip, as it will referred to hereinafter, of an electrically resistive material, preferably a metal or alloys thereof.

Said flat strip of resistive material is shaped in a corrugated or a saw-toothed manner according to different patterns or variants, which however share in all cases the feature according to which the two opposite edges of said strip are so shaped as to come to lie on two distinct respective planes, in which said two planes are furthermore parallel to each other.

A further basic feature shared by all the above mentioned possible variants in the shaping of said strip is given by the fact that such a strip is formed by a sequence of planar lengths and curved lengths, in which said different lengths are mutually alternated, and in which said curved lengths are curved either in a sharp manner, so as to confer a saw-toothed profile to the strip, or with a more smooth, continuous curvature along a short length of the flat strip.

Furthermore, at least some of said planar lengths are connected to respective appendices that are at least partially inserted in said base of insulating material 1, in which said appendices are connected to a same edge of the respective flat strip.

With reference to the Figures, these can be noticed to represent some embodiments of the resistive flat strip according to the present invention. In particular, it can be noticed that FIGS. 2A, 2B and 2C illustrate a flat strip 5 which is formed with a saw-toothed pattern with a plurality of alternate tips 22, 23, 24, 26, 27; according to the present invention, between two tips 24, 26 oriented in the same direction there are arranged two tips 26a and 26b that are bent to a lesser extent by such an angle that the intermediate planar length 28 lying therebetween is a planar length preferably parallel to the direction X of extension of said flat strip 5, and anyway orthogonal to the two parallel planes containing the opposite edges of the flat resistive strip.

According to the present invention, said planar length 28 is provided with a planar anchorage appendix 29, which is coplanar with said planar length 28 and is adapted to engage said base 1 by being inserted therein, as this is illustrated in FIG. 2C that shows two illustrations of said appendix 29, in one of which the latter is partially sectioned according to the same plane of section as the base 1 and in the other one the said appendix 29b is protruding from the same plane of section.

A different embodiment is illustrated in FIGS. 3A, 3B and 3C, in which the flat strip 5 is shaped to a saw-toothed configuration with a plurality of alternate tips 31, 32, 33, 34, 36, 37; according to the present invention, between two tips oriented in the same direction 34, 36 there are arranged two tips 36a and 36b that are bent to a lesser extent and by such an angle that the intermediate planar length 38 lying therebetween is a planar length aligned parallel to the direction X of extension of said flat strip 5; according to the present invention, said planar length 38 is provided with a planar appendix 39, which is coplanar with said planar length 38 and is adapted to engage said base 1 by being inserted therein 1, as this is illustrated in FIG. 3C. As compared with the afore described embodiment, this solution can be noticed to show said planar appendix 39 being in turn provided with two further auxiliary planar appendices 391 and 392 located at the opposite vertical edges thereof and oriented in a manner so as to be non-coplanar with the respective planar appendix 39; furthermore, said two further planar appendices 391 and 392 are arranged along planes that are orthogonal to the upper planar surface W of said insulating base 1, so that the pressure of said flat strip 5 against said base does not only cause said first appendix 39 to penetrate, but also said two planar appendices 391 and 392 to be at the same time inserted edgeways in the base 1.

A third embodiment is illustrated in FIGS. 4A, 4B and 4C; according to such a solution, use is basically made of a flat resistive strip that is only partly similar to the one described in connection with the above illustrated embodiment, since the same strip undergoes in this case some modifications, as far as its implementation and assembly arrangement on the base 1 are concerned, in the following manner: as regards the form of implementation thereof, the respective planar length 48 is provided with a planar appendix 49, which however is no longer coplanar with said planar length 48, but is rather oriented at a right angle with respect thereto and arranged in the zone opposite to the tips 42, 43 of the flat strip, which lie on the opposite sides of said plane length 48.

Similarly to the afore described case, this solution can be noticed to show said planar appendix 49 being in turn provided with two further side planar appendices 491 and 492 located at the opposite free edges thereof and oriented in a manner so as to be non-coplanar with, but rather orthogonal to the respective planar appendix 49.

As far as the assembly arrangement thereof is concerned, said resistive strip is mounted in such a manner as to cause the tips to lie in a position that is not orthogonal to the surface of the base 1, but are alternately resting thereupon or are slightly inserted therein, so as the free tips 41 and 44 lying above said surface W of said insulating base 1. In this manner, the respective planar length 48 comes to lie fully parallel to and adhering against said surface of the base 1, and also in this case both said planar appendix 49 and said two further side appendices 491 and 492 are capable of being inserted edgeways in the base 1.

Preferably, as this is shown in FIGS. 4B and 4C, said side appendices 491 and 492 are bent so as to lie exactly under said resistive strip, in such a manner as to cause a niche, as defined by the four walls 48, 49, 491 and 492, to be thereby determined.

However, the above illustrated technical solutions, although quite effective and easily implemented, have following drawback in the real practice: since there are provided both corrugated resistive lengths and planar resistive lengths, the presence of the last mentioned lengths imposes, for a same total power output, a heating element that is “longer” than it would actually be if it were formed by only a single corrugated length. From this fact the need therefore arises for the flat resistive strip to be wound with a greater number of turns or bends, which would of course become too thick, ie. too closely packed, and this would bring problems with it from both a manufacturing and a functional point of view.

In view of doing away with such a drawback, and with reference to FIGS. 5A through to 5E, it has been found that an advantageous embodiment of the present invention is reached if the planar lengths, to which said planar anchoring appendices are applied, are completely eliminated (which in practice means that the flat resistive strip is formed by a single corrugated length), whereas the anchoring appendices are in this case provided directly on the corrugated or saw-toothed walls that form the flat resistive strip between contiguous tips thereof. However, since one of the basic peculiarities of the present invention lies in the fact that said anchoring appendices are planar, it ensues that also the wall of the flat strip from which they extend must be planar, so that the flat resistive strip ultimately takes a saw-toothed form or a triangular form, with the tips that may maintain an adequately roundish curvature, while the walls between successive tips become strictly planar, under exclusion of any corrugated conformation.

FIGS. 5A, 5B and 5C illustrate a flat resistive strip 5 formed by alternating planar walls 50, 51, 52, etc., with lengths 53, 54, 55 that are curved to a semicircumference, so that said planar walls come to lie preferably equally long and facing each other. Both said planar walls and the respective curved lengths are orthogonal to the insulating base 1.

In correspondence of said planar walls, and on the same edge facing the insulating base 1, there are applied respective appendices 501, 511, 521, etc., which, similarly to the afore considered cases, are inserted edgeways into said insulating base, and which ensure the stability of the related flat resistive strip when the latter is applied on the base with said planar lengths 50, 51, 52, etc. arranged orthogonally thereto.

Such a conformation allows for following two variants: the first one of these variants is based on the fact that the anchoring appendices 501, 502, 503 are joined to respective planar walls 50, 51, 52 . . . that follow each other, ie. are arranged successively with respect to each other, as this is best illustrated in FIG. 5E; in the case of the second variant, which is illustrated in FIG. 5D, said planar walls 450, 451, 452, etc. are on the contrary parallel to each other, so that also the respective anchoring appendices 501, 502, 503 . . . are of course parallel to each other.

It has however been noticed that the afore considered solutions, based on appendices joined to the flat resistive strip over the whole width of said appendices and, therefore, over rather extended lengths, lead as an obvious result to a modification and, more precisely, a reduction in the ohmic resistance in correspondence thereof. Since a rather high current is actually supplied, such a reduction in the electric resistance translates into a corresponding reduction in the power output along said lengths, and this of course leads to the ultimate result of a decay in the overall performance of the hotplate, a much slower temperature rise pattern and also a quicker weardown brought about by the different thermal expansion pattern determined by the different heat outputs occurring along contiguous lengths of the strip.

In order to do away with such drawbacks, and with particular reference to FIG. 6, use id made of appendices 19, made according to and adapted to be engaged in any of the afore illustrated manners, which are adapted to be joined to the respective planar lengths 28, 38 by means of respective joining means 9 applied on to a same side edge 10 of said flat strip of resistive material, and coplanar with the respective planar length.

The peculiarity of this invention lies in the fact that the width d1 of said joining means 9, which are preferably constituted by metal links that are punched integrally with the flat resistive strip, is substantially smaller than the length D of the entire appendix, so that the ohmic resistance of the flat resistive strip is not altered to any significant extent, while still ensuring good mechanical securing and holding properties owing to the width of the portion of appendix that is inserted in the insulating base remaining almost constant.

In the course of laboratory tests and experiments, which have been carried out by placing the appendix illustrated in FIG. 6 on an electrically and thermally insulating test rig represented in FIG. 7, it has been furthermore observed that an acceptable electric and mechanical result is attained when the ratio of the width D2 of said flat strip to the width d1 of said joining means 9 is at least 3.0.

The results of these tests are summarized in the thermographies illustrated in FIGS. 8, 9 and 10, which display the heat output characteristic of the corrugated heating element provided with an appendix as illustrated in FIG. 6 in the three cases in which, with the given dimensions, the width d1 of the joining means is 0.5-1.0-2.0 mm, respectively, whereas D2 is constant at a width of 4.6 mm.

All other characteristics and specifications of the specimens are similar and, in particular, h=1.2 mm.

From the above cited thermographies it clearly appears that, with d1=0.5 mm, the thermal behaviour of the related length of corrugated heating element is not altered to any appreciable extent.

Such a behaviour is confirmed by the following measurements described with reference to FIGS. 11 and 12; in the first one of these Figures, a length of corrugated heating element, provided with an appendix 10 of the illustrated kind, is energized in the regular manner, while generally indicated at A and B there are the two zones that lie close to and far from said appendix, respectively.

FIG. 12 is a diagrammatical view, in which the width d1 of the joining means 9 of FIG. 6 is indicated in the abscissa, whereas the temperature difference TB-TA between the above indicated zones A and B, when the corresponding flat resistive strip is energized so as to take a temperature of approx. 900° C., is indicated in the ordinate.

It fully clearly appears that, as these joining means become thinner and thinner, the temperature difference between the above mentioned zones progressively decreases down to almost zero, which thing further demonstrates that the presence of appendices of the herein described kind may not affect the thermal behaviour of a corrugated heating element according to the present invention to any extent whatsoever. It should furthermore be noticed that it is preferable if such joining means are formed to a rectangular shape (FIG. 11), in which one of the axes (a) of the resulting rectangles is orthogonal to the axis (b) of said flat resistive strip 5.

It has also been considered that the exiguity of the width of said joining means 9 used to unite the appendix 19 to the flat resistive strip 5 might lead to an undesired weakening thereof; therefore, in view of doing away of such a risk source, following advantageous variant is proposed. With reference to FIGS. 13A, 13B and 13C, which illustrate the kind of flat resistive strip provided with planar appendices 29A that is generally similar to the flat resistive strip illustrated in FIGS. 2A, 2B and 2C with the respective planar appendices 29, this improvement of the invention consists in providing said planar appendices 29A with at least a through-perforation 99, in which the purpose of such a perforation is to reduce the common section 100 between the planar appendix 29A and the corresponding length of the flat resistive strip 5, however without introducing any unacceptable weakening effect in the connection of such elements to each other.

The advantageous result is thereby attained that said planar appendices 29A, although provided with said perforations 99, constitute neither a weakening factor nor a cause of uncertain securing of said resistive strip 5 in said base of insulating material 1, while said perforations 99 are on the contrary adequate in view of reducing the width of said common section 100 to a desired extent, so that the electric behaviour of said planar appendices 29A and the corresponding lengths of flat resistive strip 5 resembles in an almost indistinguishable and, therefore, advantageous manner the behaviour of the appendices of the kind illustrated in FIG. 6.

It will also be readily appreciated that the solution calling for appropriate perforations 99 to be provided in respective planar appendices can favourably be applied also to all variants and embodiments of the types of planar appendices illustrated in FIGS. 3A through to 5D, which, for reasons of greater simplicity and owing to them being capable of being readily understood by those skilled in the art, shall not be specifically represented here.

1. Electric radiant hotplate, particularly for use in cooking tops, comprising:
a base of thermally and electrically insulating material (1),
a peripheral crown (3) arranged along the outer rim of said base and projecting upwards,
at least a flat strip of resistive material (5) that is partially inserted in said base (1), and is formed by a sequence of planar lengths and curved lengths,
at least some of said planar lengths being connected to respective anchoring appendices (29, 39, 49, 501, 19) that are at least partially inserted in said base of insulating material (1) and are constituted by planar surfaces,
characterized in that there are provided a plurality of aligned planar lengths (28) that are parallel to the direction of extension (X) of said flat strip (5),
that said appendices (29) are coplanar with said planar lengths and are applied on a same side edge of said flat strip of resistive material,
and that the large surface of said strip is basically placed and oriented in orthogonal way with respect to said base.

2. Electric radiant hotplate according to claim 1, characterized in that said appendices comprise:
a first portion (39) that is coplanar with the respective planar length,
at least a second planar portion (391, 392), which is not coplanar with said first portion and is joined thereto via a respective rectilinear edge,
in which said non-coplanar portions are applied to opposite extremities of said first coplanar portion (39).

3. Electric radiant hotplate according to claim 1, characterized in that said appendices comprise:
a first portion (49) that is not coplanar with the respective planar length (48) and is preferably orthogonal thereto,
at least a second planar portion (491, 492) that is coplanar with neither said first portion nor respective planar length, and is joined thereto via a common rectilinear edge,
in which said planar lengths (28) are arranged entirely parallel to the surface of said base (1) and adjacent thereto.

4. Electric radiant hotplate according to the preamble of claim 1, characterized in that:
said flat strip of resistive material is formed by a sequence of planar walls (50, 51, 52) orthogonal to said base and joined to each other via respective variously shaped tips or cusps,
none of said planar walls is parallel to the direction of extension of said flat strip,
at least some of said planar walls are joined to respective planar appendices (501, 502, 503), which are coplanar with the respective wall,
said appendices (501, 502, 503) are applied on a same side edge of said flat strip of resistive material, and
no more than one of said appendices is joined to the corresponding planar wall.

5. Electric radiant hotplate according to claim 4, characterized in that said planar walls (50, 51, 52) are arranged parallel to each other.

6. Electric radiant hotplate according to claim 4, characterized in that said anchoring appendices (501, 502, 503) are joined to respective planar walls that follow each other or are contiguous to each other in a sequence.

7. Electric radiant hotplate according to claim 1, characterized in that said appendices (19) are joined to said planar lengths by means of respective joining means (9) applied on a same side edge (10) of said flat strip of resistive material, and coplanar with the respective planar length.

8. Electric radiant hotplate according to claim 7, characterized in that the ratio of the width (D₂) of said flat strip to the width (d1) of said joining means (9) is at least 3.0.

9. Electric radiant hotplate according to claim 7, characterized in that said joining means are formed to a rectangular shape, in which one of the axes (a) of the resulting rectangles is orthogonal to the axis (b) of said flat strip of resistive material.

10. Electric radiant hotplate according to claim 1, characterized in that said planar appendices (29, 39, 49, 501, 19, 29A) are provided with respective through-perforations (99).

11. Electric radiant hotplate according to claim 9, characterized in that said through-perforations (99) are located near the common section (100) between said planar appendices and the corresponding lengths of said flat strip of resistive material.

12. Electric radiant hotplate according to claim 5, characterized in that said anchoring appendices (501, 502, 503) are joined to respective planar walls that follow each other or are contiguous to each other in a sequence.

13. Electric radiant hotplate according to claim 8, characterized in that said joining means are formed to a rectangular shape, in which one of the axes (a) of the resulting rectangles is

14. Electric radiant hotplate according to claim 2, characterized in that said planar appendices (29, 39, 49, 501, 19, 29A) are provided with respective through-perforations (99).

15. Electric radiant hotplate according to claim 3, characterized in that said planar appendices (29, 39, 49, 501, 19, 29A) are provided with respective through-perforations (99).

16. Electric radiant hotplate according to claim 4, characterized in that said planar appendices (29, 39, 49, 501, 19, 29A) are provided with respective through-perforations (99).

17. Electric radiant hotplate according to claim 5, characterized in that said planar appendices (29, 39, 49, 501, 19, 29A) are provided with respective through-perforations (99).

18. Electric radiant hotplate according to claim 6, characterized in that said planar appendices (29, 39, 49, 501, 19, 29A) are provided with respective through-perforations (99).

19. Electric radiant hotplate according to claim 12, characterized in that said planar appendices (29, 39, 49, 501, 19, 29A) are provided with respective through-perforations (99).

20. Electric radiant hotplate according to claim 7, characterized in that said planar appendices (29, 39, 49, 501, 19, 29A) are provided with respective through-perforations (99).
